(19) United States
(12) Patent Application Publication
(10) Pub. No.: US 2009/0145515 A1
(43) Pub. Date: Jun. 11, 2009

(54) Absorbent bib for inlet of fuel tank

(76) Inventor: Lewis R. Gotch, Sandy Hook, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/315,492

(22) Filed: Dec. 3, 2008

Related U.S. Application Data
(60) Provisional application No. 61/005,320, filed on Dec. 3, 2007.
(60) Provisional application No. 61/025,475, filed on Feb. 1, 2008.

(51) Int. Cl. B67D 5/06

(52) U.S. Cl. 141/88

(57) ABSTRACT

An absorbent bib comprising an absorbent pad made of a biochemical absorbent material, the absorbent pad having a top portion configured with an opening for receiving and engaging the neck of a fuel opening of a fuel tank of a vehicle or vessel, such as a passenger vehicle, motorcycle, marine vessel, or aviation applications, e.g. a small airplane, so that the bib can be hung on the neck when a bio-chemical fuel is being dispensed in the tank, and the absorbent pad also having a bottom portion configured for hanging below the opening so as to absorb at least some of the bio-chemical fuel that may spill either when a nozzle for dispensing the bio-chemical fuel is inserted into or removed from the fuel opening, or when the tank is over-filled.

### CROSS REFERENCE TO RELATED APPLICATION

Reference is made to and priority claimed from U.S. provisional application Ser. No. 61/005,320, filed Dec. 3, 2007, and U.S. provisional application Ser. No. 61/025,475, filed Feb. 1, 2008, each entitled ABSORBENT BIB FOR INLET OF GASOLINE TANK, which are both hereby incorporated by reference in their entirety.

### BACKGROUND OF THE INVENTION

1. Technical Field

The present invention relates to an absorbent bib for the inlet fuel opening of a fuel tank on a vehicle or apparatus that utilizes fossil fuel, such as an automobile, a motorcycle, a marine vehicle, or aviation applications, e.g. a small airplane, for absorbing excess gasoline, diesel or other bio-chemical fluids that may escape or spill from the gas tank or fuel nozzle during refueling.

2. Discussion of Related Art

Absorbent materials are known in the art which can absorb fluids that can comprise chemical spills. What is lacking in the art, however, is a product that combines such absorbent materials with a novel design such that the material is formed into a protective pad that can be utilized to prevent fuel spills in a variety of vehicles. Fuel spills at filling pumps at filling stations is very common. Along with damage to the ground caused by spilling fuel, oil, brake fluid, etc. during re-filling, such spills can also damage paint finish on a vehicle, or cause a fire, such as e.g. if oil is spilled on a motor. Additionally, all such spills ultimately seep into the ground causing environmental contamination.

What is needed, therefore, is as an absorbent bib for the inlet fuel opening of a gasoline tank on a vehicle or apparatus that utilizes fossil fuel, such as an automobile, a motorcycle, a marine vehicle, or aviation applications, e.g. a small airplane, for absorbing excess gasoline, diesel or other bio-chemical fluids that may escape or spill from the gas tank or fuel nozzle during refueling.

### DISCLOSURE OF INVENTION

Accordingly, in accordance with a first broad aspect of the invention, a bib may comprise an absorbent pad having one or more protection layers made of a bio-chemical absorbent material, the absorbent pad having a top portion configured with an opening for receiving and engaging a neck of a fuel opening of a tank of a vehicle or vessel so that the bib can be hung on the neck when a bio-chemical fuel is being dispensed in the tank, and the absorbent pad also having a bottom portion configured for hanging below the opening so as to absorb at least some of the bio-chemical fuel that may spill either when a nozzle for dispensing the bio-chemical fuel is inserted into or removed from the fuel opening, or when the tank is over-filled.

In some embodiments, the top portion of the bib may comprise circumferential portions arranged about the opening and configured to flex and frictionally engage the neck so that the bib hangs securely on the tank. The circumferential portions may be serrated or perforated. The circumferential portions may include eight circumferential portions symmetrically arranged about the opening, wherein each adjacent pair of the circumferential portions may be separated by a respective radial cut in the absorbent pad. The top portion of the bib may be configured with diametrically opposing pairs of radial cuts having longer and shorter lengths so that alternating adjacent circumferential portions flex open wider for hanging the bib on the tank.

In some embodiments, the top portion of the bib may comprise circumferential portions formed or shaped as wrinkles, folds or alternating ridges about the opening and configured to flex and frictionally engage the neck so that the bib hangs securely on the tank.

In some embodiments, the vehicle or vessel may include a passenger vehicle, a motorcycle, a marine vessel, or an airplane.

In some embodiments, the bib may further comprise a flame-retardant material disposed thereon.

In some embodiments, the bottom portion of the bib may be configured to include a logo formed, affixed or imprinted thereon for providing advertising.

In some embodiments, the bottom portion of the bib may comprise a form-molded catch basin, said catch basin comprising a first protection layer continuous with said absorbent pad, a second protection layer coupled on top of said first protection layer, a third protection layer coupled on top of said second protection layer, said first, second and third protection layers comprised of a bio-chemical absorbent material, and a flexible formable material coupled to said first protection layer. The bib may further comprise a flexible tapered formable material coupled to said opening of said absorbent pad for further coupling with said fuel opening, said flexible tapered formable material configured to provide added stability so that the bib hangs securely on the tank.

In some embodiments, the bib may further comprise an adhesive foil disc affixed to one surface of said absorbent pad, said adhesive foil disc configured to provide added formability of the bib and stability of the coupling of the bib to the neck of the opening so that the bib hangs securely on the tank.

In some embodiments, the bio-chemical absorbent material is polypropylene.

In a second broad aspect of the invention, a protective fueling apparatus may comprise a catch cylinder comprising a cylindrical structure having a catch flange and a back flap, said catch cylinder made of a durable plastic material, said back flap configured with an opening, a filler extension tube configured for engaging with said opening, said filler extension tube configured for receiving and engaging a neck of a fuel opening of a tank of a vehicle or vessel so that the catch cylinder can be hung on the neck when a bio-chemical fuel is being dispensed in the tank, and an absorbent sock comprised of a bio-chemical absorbent material and filled with another bio-chemical absorbent material, said sock dimensionally sized to fit inside said catch cylinder.

In some embodiments, said vehicle may be a marine vessel or an airplane.

In some embodiments, the protective fueling apparatus may further comprise a flame-retardant material disposed on said bio-chemical absorbent material.

In some embodiments, the protective fueling apparatus may be further configured to comprise a logo formed, affixed or imprinted thereon for providing advertising.

In some embodiments, the protective fueling apparatus may further comprise a flame-retardant material disposed on said absorbent sock.

In some embodiments, the bio-chemical absorbent material may be polypropylene and the other biochemical absorbent material may be hydrophobic cellulose with fire retardant.

In a third broad aspect of the invention, a bib may comprise an absorbent pad having one or more protection layers made of a material configured for absorbing hazardous chemicals, the absorbent pad having a top portion configured with an opening for receiving and engaging a neck of an opening of a tank of a vehicle or vessel so that the bib can be hung on the neck when a fluid is being dispensed in the tank, the absorbent pad also having a bottom portion configured for hanging below the opening so as to absorb at least some of the fluid that may spill either when a nozzle for dispensing the fluid is inserted into or removed from the fluid opening, or when the tank is over-filled.

Such an absorbent bib or protective fueling apparatus according to the present invention may be used for re-filling applications related to motor vehicles, motorcycles, marine vessels, aviation applications, all-terrain-vehicles, lawnmowers, hedge trimmers, weed trimmers, dirt bikes, chain saws, etc., or any machinery or motor vehicle that requires petroleum based fluids to function. Such fluids may include gasoline, motor oil, brake fluid, 2 cycle oil, antifreeze, power steering fluid, transmission fluid, etc.

### BRIEF DESCRIPTION OF THE DRAWINGS

The above and other objects, features and advantages of the invention will become apparent from a consideration of the subsequent detailed description presented in connection with accompanying drawings, which are not intended to be drawn to scale, in which:

FIG. 1 is a front view of an absorbent bib of the present invention generally for use with passenger motor vehicles;

FIG. 2a(1) is a schematic view of the absorbent bib of FIG. 1;

FIG. 2a(2) shows a collection of various advertising logos that may be formed, affixed or imprinted on the absorbent bib of FIG. 1;

FIG. 2b(1) is a schematic view of an alternative shape and arrangement of the absorbent bib of FIGS. 1 and 2a(1);

FIG. 2b(2) is a side view of the absorbent bib of FIG. 2b(1);

FIG. 3a is a schematic view of an absorbent bib of the present invention generally for use with motorcycles;

FIG. 3b shows a collection of various advertising logos that may be formed, affixed or imprinted on the absorbent bib of FIG. 3a;

FIG. 4a is a front view of a custom dispenser for dispensing the absorbent bib of FIGS. 1-2;

FIG. 4b is a top view of the custom dispenser for dispensing the absorbent bib of FIGS. 1-2;

FIG. 4c is a cross-sectional view of the custom dispenser of FIGS. 4a and 4b;

FIG. 5 is a perspective view of a catch cylinder and filler extension tube of the present invention generally for use with marine vehicles;

FIG. 6 is a side view of an absorbent sock of the present invention for fitting into the catch cylinder of FIG. 5;

FIG. 7a is a side view of an absorbent bib of the present invention in an alternative embodiment generally for use with marine vessels;

FIG. 7b is a modified top view of the absorbent bib of FIG. 7a;

FIG. 8a is a modified top view of an alternative arrangement of the absorbent bib of FIGS. 7a and 7b;

FIG. 8b shows a collection of various advertising logos that may be formed, affixed or imprinted on the absorbent bib of FIG. 8a;

FIGS. 9a-9d show perspective views of the absorbent bib of FIG. 2b as coupled to a fuel tank of a vehicle;

FIGS. 10a-10d show perspective views of the absorbent bib of FIGS. 7a-7b and 8 as coupled to a fuel tank of a marine vessel; and

FIGS. 11a-11c show perspective views of the absorbent bib of FIG. 4 as coupled to a fuel tank of a motorcycle.

### DETAILED DESCRIPTION

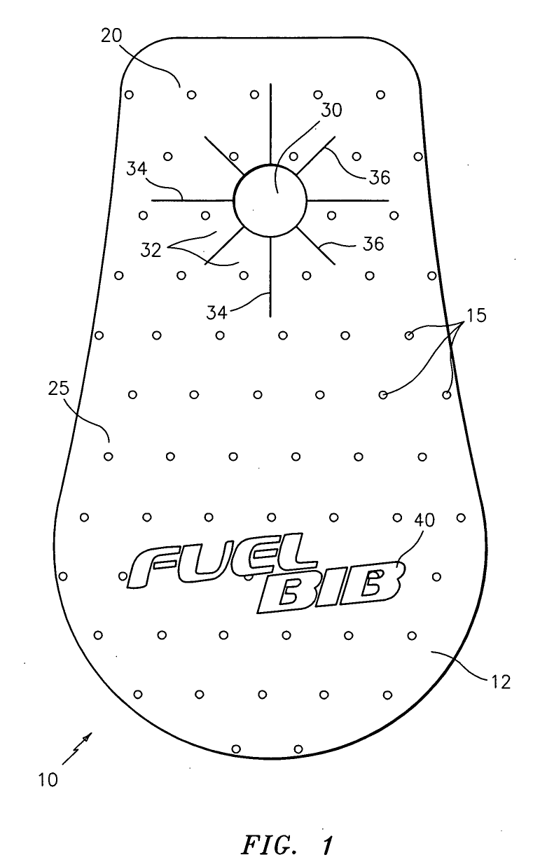

As shown in FIGS. 1-11, the present invention features an eco-friendly disposable protective absorbent material used to protect a vehicle's paint finish and more importantly to protect the ground and environment where refueling takes place.

FIGS. 1,2a(1)-2b(2) and 9: The Passenger Vehicle Embodiment

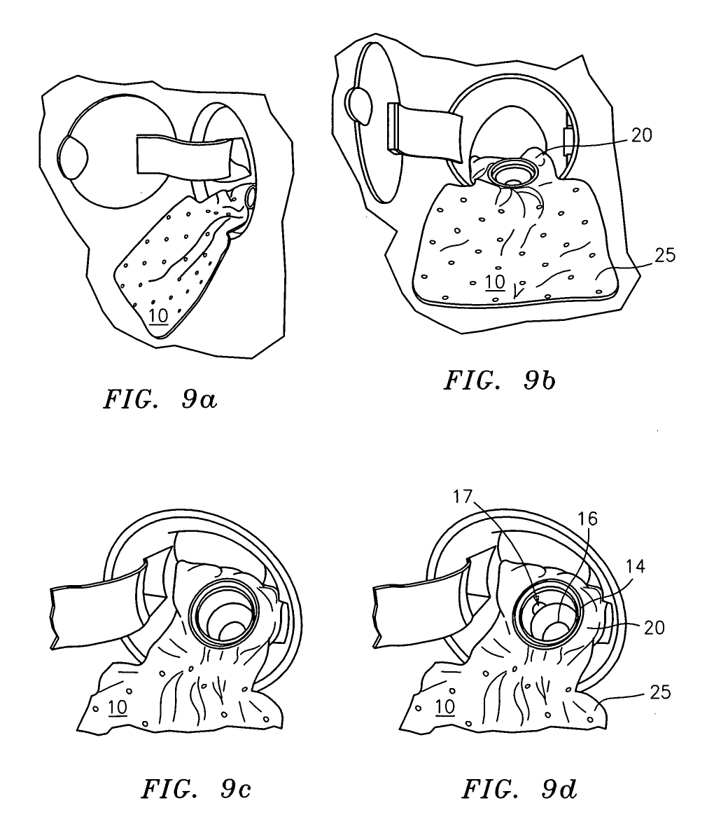

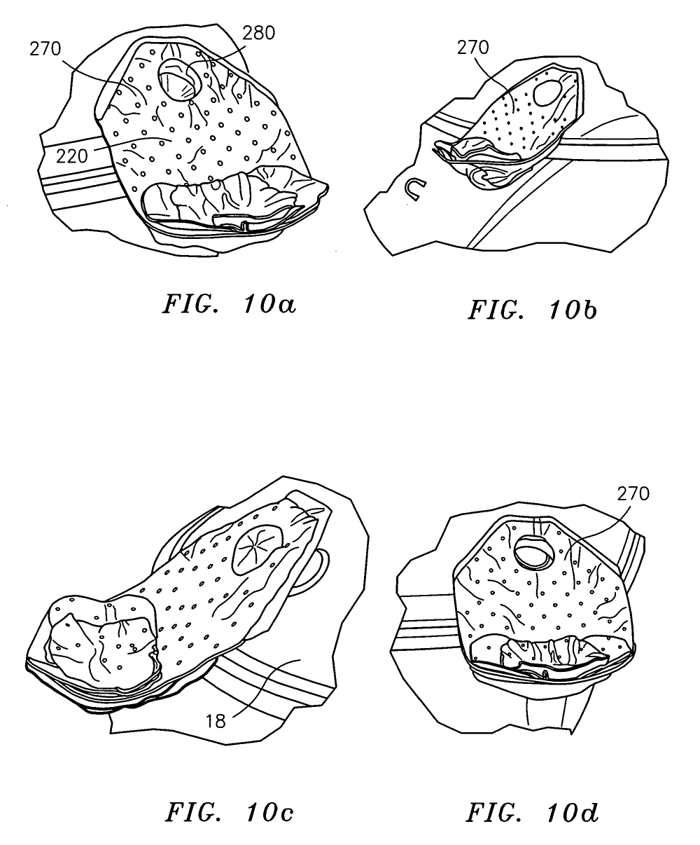

FIG. 1 shows, by way of example, one embodiment of an absorbent bib generally indicated as 10 according to the present invention, featuring an absorbent pad 12 having one or more protection layers made of a bio-chemical absorbent material. The absorbent pad 12 has a top portion 20 and a bottom portion 25. The top portion 20 is configured with an opening 30 for receiving and engaging a neck 14 (see FIG. 9) of a fuel opening 16 of a tank generally indicated as 17 (see FIG. 9) of a vehicle or vessel 18 (See FIG. 10) so that the absorbent bib 10 can be hung on the neck 14 when a bio-chemical fuel is being dispensed in the tank . FIG. 9 shows the absorbent bib 10 arranged on the neck of the fuel opening according to some embodiments of the present invention. The bottom portion 25 is configured for hanging below the opening 30 so as to absorb at least some of the biochemical fuel that may spill either when a nozzle (not shown) for dispensing the biochemical fuel is inserted into or removed from the fuel opening 16, or when the tank 17 is over-filled.

As shown in FIG. 1, in one embodiment of the invention, the absorbent bib 10 may be utilized in passenger vehicles, such as cars, trucks, and other vehicles having two or more doors or seats. The scope of the invention is not intended to be limited to the type or kind of vehicle either now known or later developed in the future. The absorbent bib 10 may be substantially pear-shaped, having a smaller region located at the top portion 20 of the absorbent bib 10 through which the opening 30 may be punched or stamped. The neck 12 of inlet opening 14 of the fuel tank 17 is coupled to the opening 30, as best shown in FIG. 9.

As shown in FIG. 1, the top portion 20 may include circumferential portions 32 arranged about the opening 30 and configured to flex and frictionally engage the neck so that the absorbent bib 10 hangs securely on the tank 17, as best shown in FIG. 9. FIGS. 9a-9d show various views of the absorbent bib 10′ coupled to the fuel tank of a motor vehicle. This circumferential portions 32 help prevent the absorbent bib 10 from becoming displaced or disengaged from the neck 14 of fuel tank 17 due to the force of a blowing wind or other environmental factors, as well as being knocked off by the nozzle when filling the tank. As shown, the circumferential portions 32 include eight circumferential portions that are substantially triangularly shaped and symmetrically arranged about the opening 30, although the scope of the invention is intended to include embodiments having a different number of circumferential portions. Each adjacent pair of circumferential portions 32 may be formed and separated by a respective radial cut 34, 36 in the absorbent pad. It has been found that a stamping process, discussed below, can effectively be used to make the absorbent bib 10, including the opening 30 and the radial cuts 34, 36. As shown, the radial cuts 34, 36 may be formed in diametrically opposing pairs comprising longer cuts 34 and shorter cuts 36 arranged such that alternating adjacent circumferential portions 32 flex open wider for hanging the absorbent bib 10 on the tank.

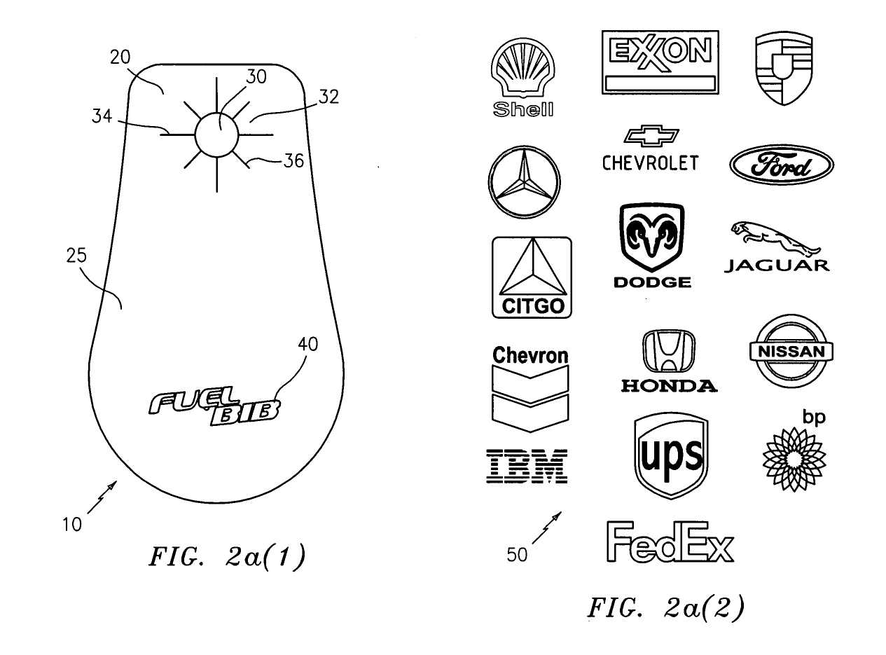

As shown in FIG. 2b(1), the absorbent bib 10 may include serrated, or perforated, or corrugated portions 24′ configured about the opening 30 that can also aid in keeping the absorbent bib 10 coupled to the opening of the fuel tank during refueling.

By way of example, in one embodiment, the bio-chemical absorbent material being used is manufactured by New Pig Corporation of Three Pork Avenue, Tipton, Pa. 16684, which is 97% polypropylene and 3% yellow pigment, although the scope of the invention is intended to include other type or kinds of bio-chemical absorbent material either now known or later developed in the future, such as for example PAD310 Absorbent Pad, manufactured by Dawg of 25 Lassy Court, Terryville, Conn. 06486. The absorbent material can be purchased in a pre-cut custom size, 11×24 inches. The absorbent material may also be comprised of 100% polypropylene and may be manufactured into a fibrous or non-fibrous arrangement. The absorbent material may include heated pin depressions 15, as shown in FIG. 1, which result from the fabric manufacturing process and serve to hold the material layers together.

The absorbent bib may be coated with an application of an organic and non-hazardous flame-retardant, making the absorbent bib safe for disposal. By way of example, the chemical comprising the flame retardant may be purchased from Flame Stop, Inc. of 924 Bluemound Road, Fort Worth, Tex. 76131. One example of the chemical is Flame Stop I-DS™ and is a pyrolitic formulation that prevents the spread of flames by developing a chemically self-extinguishing reaction. Flame Stop I-DS™ is a clear, penetrating chemical. The flame-retardant chemical may be applied to the 11×24 sheets of absorbent material by airless atomization spray application to both sides of the absorbent material.

The absorbent material may be altered/manipulated into different shapes as shown in FIGS. 1-3 and 7-11 by an automated die. The absorbent bib shape may be cut with a four up steel die in a tonnage press. All aspects of the absorbent bib may be produced during the stamping process. The automated die may have heating properties to heat-seal the edges of the absorbent bib.

In order for the absorbent bib to work effectively with all vehicle openings, an adhesive foil disc may be affixed to the absorbent material prior to the stamping process to provide added form fitting rigidity, thereby increasing the number of uses. For example, in the event that a tank opening is flush or depressed into the structure, the flexible foil of the absorbent bib can provide the ability to form fit the application of the bib to the tank. Such form-fitting may be effected by pressing portions surrounding the opening of the absorbent bib 10 into the opening of the fuel tank.

Each absorbent bib 10 may be heat embossed by a brass stamp with one or more Fuel Bib® logos. Fuel Bib® is a registered trademark of Lewis R. Gotch. Logo application may also be provided by silk screening, pad printing, or foil hot stamping processes. In order to make the product specific and usable as a potential marketing and advertising tool, each absorbent bib and/or each custom dispenser also may be imprinted with an organizational logo, such as the logo of a gasoline station, an automobile manufacturer, a corporation, etc., as shown in FIGS. 2a(2), 3b and 8b. The logos shown in FIG. 2a(2) are registered trademarks of the companies depicted in the logos.

In FIG. 2a(1), the absorbent bib 10 is shown, by way of example, with a set of dimensions for one embodiment of the same. However, the scope of the invention is not intended to be limited to any particular dimension for making the absorbent bib 10, since embodiment are envisioned for embodiments having different sets of dimensions. In particular, by way of example, the average size of the opening 30 may be approximately 1.0 inch, although the scope of the invention is intended to include other dimensions. Also shown by way of example, the average size of the absorbent bib may be approximately 10.0 inches long, 6.0 inches at its widest point, and 4.0 inches at its narrowest point, although the scope of the invention is intended to include other dimensions. The opening 30 may be located approximately 1.75 inches from the top edge of area 20. The perforated areas include perforations approximately 0.75 to 1.0 inches in length shown in a starburst pattern. The bottom portion 25 of absorbent bib 10 may include an imprinted logo 40, such as shown in FIG. 2a(2) as group 50. The scope of the invention is not intended to be limited to the shape or kind of bio-chemical absorbent material that the absorbent bib is made of either now known or later developed in the future.

FIG. 2b(1) shows an alternative shape and arrangement of the absorbent bib of FIG. 2a(1). An absorbent bib 10′ may be utilized in passenger vehicles, such as cars, trucks, and other vehicles having two or more doors or seats. The absorbent bib 10′ may be somewhat rectangular-shaped, having a smaller region located at the top portion 20′ through which an opening 30′ may be punched. The inlet opening of a fuel tank is coupled to the opening 30′. An optional serrated or perforated or corrugated aspect of the opening 30′ aids in keeping the absorbent bib 10′ coupled to the opening of the fuel tank during refueling. The serrated points may be made from a flexible formable material, such as high density Polyethylene plastic material, heat-molded to the opening 30′ of the absorbent bib 10′. The average size of the opening 30′ may be approximately 2.25 inches. The average size of the absorbent bib may be approximately 10.0 inches long, 6.0 inches at its widest point, and 4.0 inches at its narrowest point. The absorbent bib 10′ may include an imprinted logo 40′, such as shown in FIG. 2a(2) as group 50. The scope of the invention is not intended to be limited to the shape or kind of bio-chemical absorbent material that the absorbent bib is made of either now known or later developed in the future.

FIG. 2b(2) shows a side view of the absorbent bib 10′ of FIG. 2b(1) having a top portion 20′ and bottom portion 25′. The shape shown in FIG. 2b(2) is not illustrative of the form of the absorbent bib 10′ after the edges have been heat-sealed.

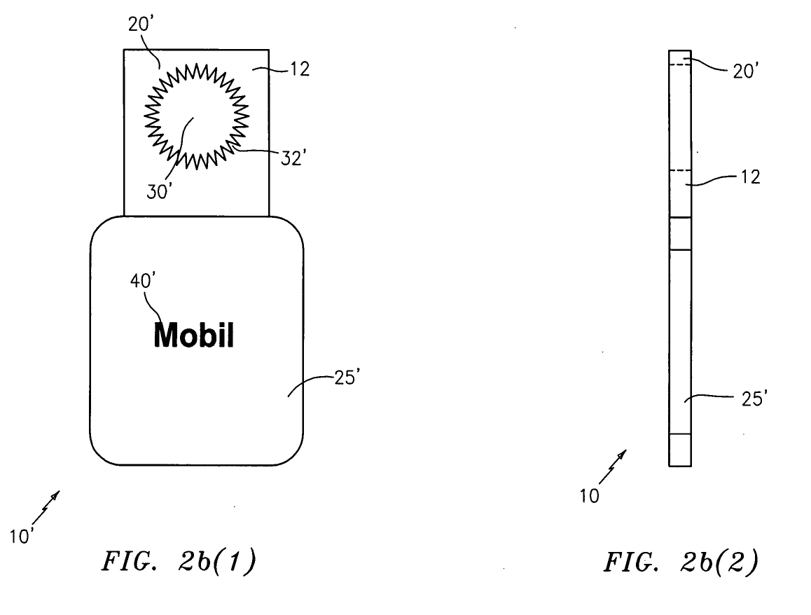

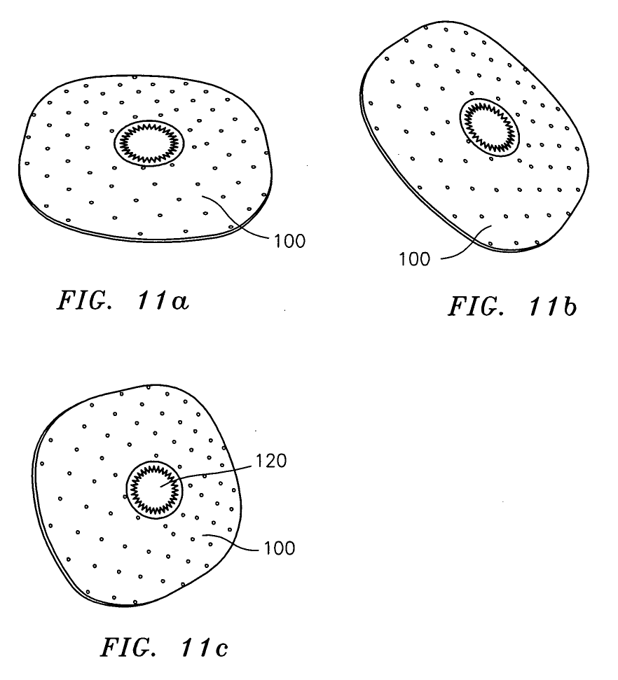

FIGS. 3a-3b and 11: The Motorcycle Embodiment

As shown in FIG. 3a, in another embodiment of the invention, an absorbent bib 100 may be utilized in motorcycles, as shown in FIG. 11, which shows various views of the absorbent bib 100 coupled to a fuel tank for a motorcycle.

The absorbent bib 100 may be round in shape having an opening 120 punched through the center. The inlet opening (not shown) of the fuel tank (not shown) is coupled to the opening 120. Consistent with that discussed above, circumferential portions like 32 (see FIG. 1), as well as perforated or serrated or corrugated portions 32′ (FIG. 2a(1) may be formed about the opening 120 to aid in keeping the absorbent bib 100 coupled to the fuel opening of the fuel tank during refueling. The serrated portions 32′ may be made from a flexible formable material, such as high density Polyethylene plastic material, heat-molded to the opening 120 of the absorbent bib 100. The average size of the opening 120 may be, by way of example, approximately 2.25 inches, although the scope of the invention is intended to include other dimensions. The absorbent bib 100 may include an imprinted logo 130, such as shown in FIG. 3b as group 140. The logos shown in FIGS. 3a and 3b are registered trademarks of the companies depicted in the logos. The scope of the invention is not intended to be limited to the shape or kind of material that the absorbent bib is made of either now known or later developed in the future.

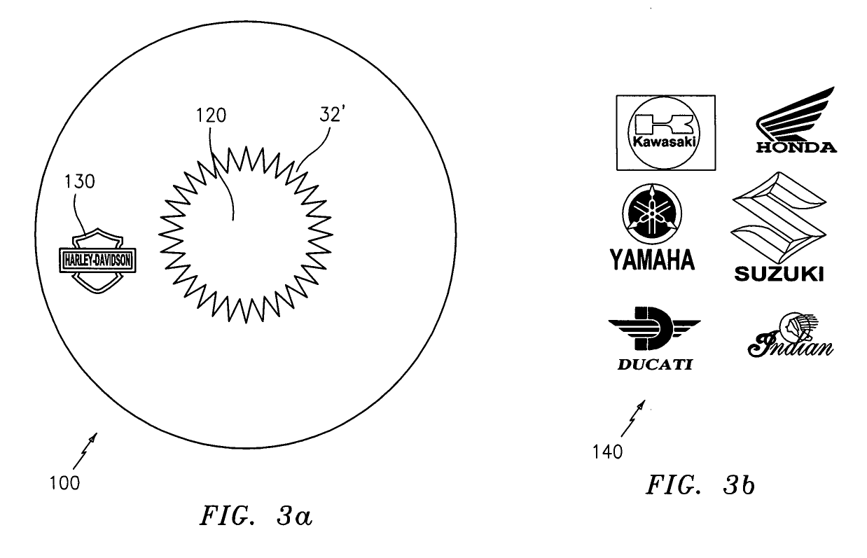

FIGS. 4a-4c: The Dispenser

As shown in FIGS. 4a, 4b and 4c, once manufactured, a group of twelve absorbent bibs 90 may be inserted into a custom dispenser 60 that is specifically designed to fit in the side door compartment of most passenger vehicles, or in the storage space of most motorcycles, allowing the user to pull out one absorbent bib at a time through an opening 80, similar to dispensing tissues from a box. After each use, the used absorbent bib may be discarded into a safe receptacle for proper disposal. The dispenser 60 may include an imprinted logo 70. FIG. 4c shows a cross-sectional view of the custom dispenser 60 as cut along line 65 in FIG. 4b. This view shows the group of absorbent bibs 90 coiled inside custom dispenser 60. The scope of the invention is not intended to be limited to the shape or kind of material that the dispenser is made of either now known or later developed in the future.

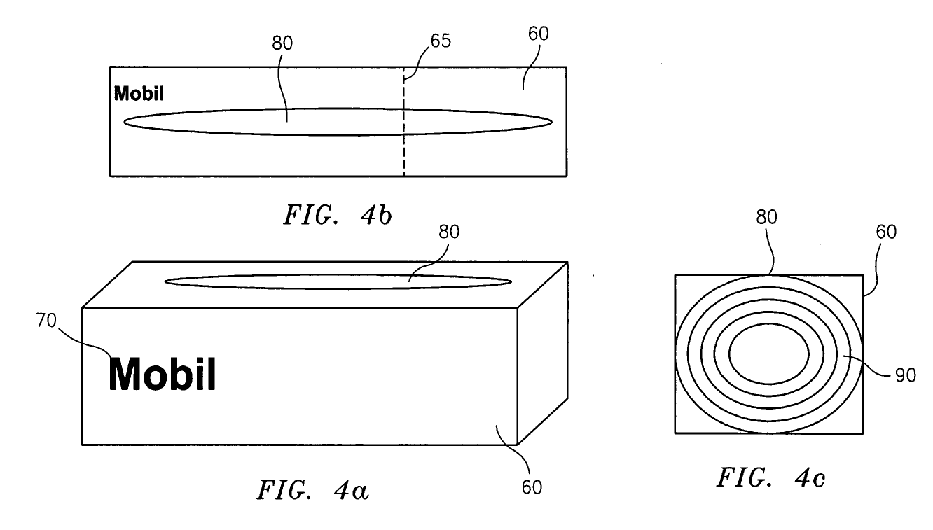

FIGS. 5-8b and 11: The Marine Embodiment

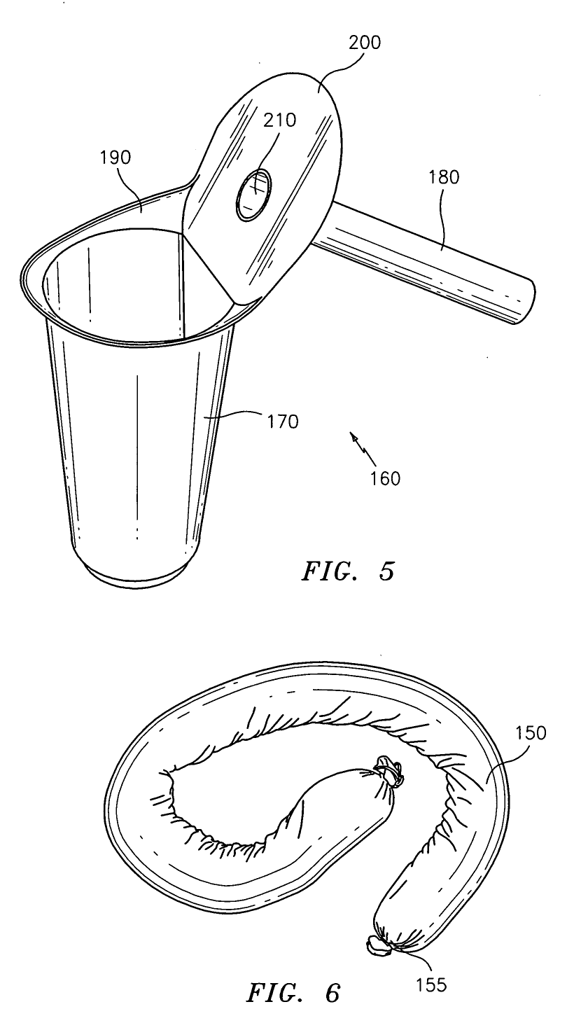

As shown in FIGS. 5 and 6, in yet another embodiment of the invention, the absorbent material may be utilized in commercial and personal marine vessels or aircraft. FIGS. 10a-10d show various views of the absorbent bib 220 coupled to the fuel tank of a marine vehicle.

An absorbent sock 150 filled with an absorbent material may be dimensionally sized and configured to fit inside a protective fueling apparatus 160 having a catch cylinder 170 and a filler extension tube 180. The absorbent sock 150 may be manufactured in three-foot sections but may be resized to meet the size requirements of the marine vessel or aircraft. Ends 155 of the absorbent sock 150 may be sealed by tying, stapling, stitching, heat-sealing or any other sealing method. The protective fueling apparatus 160 may be comprised of three functional pieces. The first piece may be a plastic mold injected cylindrical structure 170 with a catch flange 190 and a back flap 200 with a 1.75 inch opening 210 for refueling. The second piece may be a filler extension tube 180 comprised of a plastic mold injected tapered cylinder. The filler extension tube may be inserted into the back flap 200 opening 210 of the catch cylinder 170. The filler extension tube 180 may be pulled through the opening 210, tapered end first, until the two pieces are joined with a “click” sound, thereby ensuring a tight and permanent seal. The third piece my be the single use, disposable absorbent sock 150 that may be sized to 8.0 inch lengths. The absorbent sock 150 is inserted into the catch cylinder 170 and the filler extension tube 180 is inserted into the fuel opening in the vessel until it cannot be inserted further. This ensures a tight fit and seal. The fuel nozzle is then inserted into the filler extension tube 180 through the opening 210 to refuel the vessel. Any fuel that spills during the refueling process will be collected in the absorbent catch cylinder 170 and absorbed by the absorbent sock 150. The scope of the invention is not intended to be limited to the shape or kind of bio-chemical absorbent material that the absorbent sock is made of either now known or later developed in the future, nor is the scope of the invention intended to be limited to the shape or kind of material that the protective fueling apparatus is made of either now known or later developed in the future.

In order to manufacture the catch cylinder 170 and filler extension tube 180, a multi-section steel mold may be fabricated to perform the plastic mold injection function. The mold may be a machine having specific tolerances and directional draft to ensure that the part is accurate in size and shape and will properly release from the mold during fabrication.

Once the mold is created, the mold may be inserted into an automated plastic molding machine. The hopper of the machine may be filled with polypropylene plastic pellets that are heated to a specific temperature and injected into the mold, thus forming the catch cylinder 170 and filler extension tube 180. The catch cylinder 170 and filler extension tube 180 are then ejected from the mold.

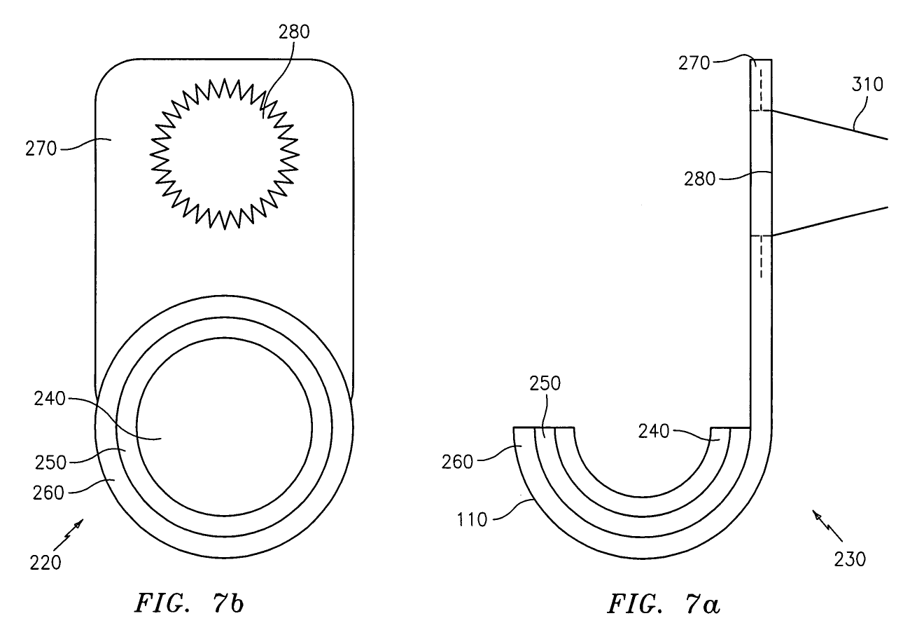

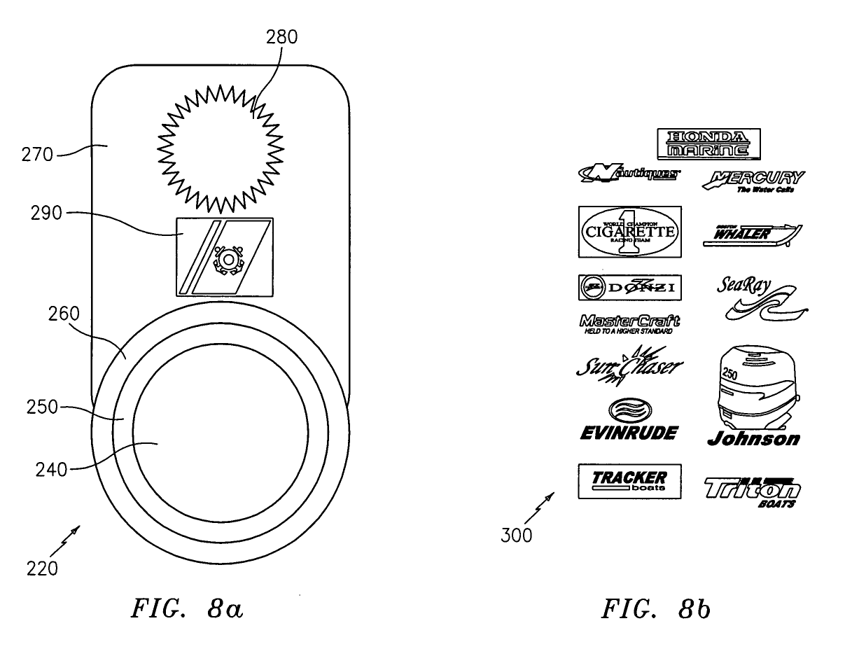

In an alternative marine embodiment shown in FIGS. 7a-7b and 8a, an absorbent bib 220 may be rectangular in shape with a rounded bottom portion, as best shown in FIG. 10. A flexible formable material 110, such as high density Polyethylene plastic material, may be heat-molded during the manufacturing process to the back side of the absorbent bib 220 to provide a catch basin 230 to collect any fuel that may be spilled onto the marine vessel or into the surrounding water. For added protection, the catch basin 230 may be triple-layered (protection layers 240, 250, 260) for extra absorption of spilled fuel. In FIG. 7a, the three protection layers 240, 250, 260 are shown with different shading for ease of viewing; however, each of protection layers 240, 250, 260 may be comprised of substantially the same absorbent material of which absorbent bib 220 is comprised, as well as combinations of different types or kinds of the absorbent material either now known or later developed in the future. The absorbent bib 220 has a top region 270 through which an opening 280 may be punched. The fuel opening of the fuel tank is coupled to the opening 280. Consistent with that discussed above, circumferential portions like 32 (see FIG. 1), as well as perforated or serrated or corrugated portions like 32′ (see FIG. 2b(1) may be formed about the opening 280 to aid in keeping the absorbent bib 220 coupled to the fuel opening of the gas tank during refueling. The serrated points may be made from a flexible formable material, such as high density Polyethylene plastic material, heat-molded to the opening 280 of the absorbent bib 220. The average size of the opening 280 may be approximately 2.25 inches. The average size of the absorbent bib 220 may be approximately 11.0 inches long, 4.0 inches wide and 4.0 inches deep. The scope of the invention is not intended to be limited to the shape or kind of biochemical absorbent material that the absorbent bib is made of either now known or later developed in the future.

The absorbent bib 220 may include an imprinted logo 290, such as shown in FIG. 8b as group 300. The logos shown in FIGS. 8a and 8b are registered trademarks of the companies depicted in the logos. Additionally, as shown in FIG. 7a, the absorbent bib 220 may have a tapered area 310 forming a “nozzle” surrounding the opening 280 to fit inside the fuel opening of the fuel tank and to be hand form-fitted at time of use. The tapered area 310 may be manufactured by extruding the flexible formable material, such as high density Polyethylene plastic material, into a funnel shaped structure that may have a lip on the larger end that may also be heat-molded to the absorbent bib 220 around the opening 280. The funnel shaped structure may also be separately inserted into opening 280 after the absorbent bib 220 is placed over the opening of the fuel tank. The scope of the invention is not intended to be limited to the shape or kind of material that the absorbent bib or flexible formable material are made of either now known or later developed in the future.

Consistent with that described above in relation to FIG. 4, once manufactured, a group of twelve to twenty-four absorbent bibs 220 may be inserted into a custom tube-shaped dispenser that is specifically designed either to hang on the marine vehicle or to store easily under a seat or motor compartment, allowing the user to pull out one absorbent bib 220 at a time, similar to dispensing tissues from a box. After each use, the used absorbent bib 220 may be discarded into a safe receptacle for proper disposal. The scope of the invention is not intended to be limited to the shape or kind of material that the dispenser is made of either now known or later developed in the future.

### SCOPE OF THE INVENTION

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

The scope of the invention is also intended to include bibs featuring an absorbent pad having one or more protection layers made of a material configured for absorbing other types of hazardous chemicals besides bio-chemicals, where the absorbent pad has a top portion configured with an opening for receiving and engaging a neck of a fluid opening of a tank of a vehicle or vessel so that a bib can be hung on the neck when such a hazardous fluid is being dispensed in the tank, and where the absorbent pad also has a bottom portion configured for hanging below the opening so as to absorb at least some of the hazardous fluid that may spill either when a nozzle for dispensing the fluid is inserted into or removed from the fluid opening, or when the tank is over-filled. By way of example, and consistent with that discussed herein, the fluid may take the form of gasoline, motor oil, brake fluid, 2 cycle oil, antifreeze, power steering fluid, transmission fluid, as well as other hazardous fluids either now known or later developed in the future. The material configured for absorbing such other type or kinds of hazardous chemicals may include in addition to the materials set forth herein, other type or kinds of materials either now known or later developed in the future for absorbing such other type or kinds of hazardous chemicals.

The scope of the invention is also intended to include a protective filling apparatus featuring a catch cylinder comprising a cylindrical structure having a catch flange and a back flap, said catch cylinder made of a durable plastic material, said back flap configured with an opening, a filler extension tube configured for engaging with said opening, said filler extension tube configured for receiving and engaging a neck of an opening of a tank of a vehicle or vessel so that the catch cylinder can be hung on the neck when a hazardous fluid is being dispensed in the tank, and an absorbent sock comprised of a material configured for absorbing other types of hazardous chemicals besides bio-chemicals and filled with another material configured for absorbing other types of hazardous chemicals besides bio-chemicals, said sock dimensionally sized to fit inside said catch cylinder. By way of example, and consistent with that discussed herein, the fluid may take the form of gasoline, motor oil, brake fluid, 2 cycle oil, antifreeze, power steering fluid, transmission fluid, as well as other hazardous fluids either now known or later developed in the future. The material configured for absorbing such other type or kinds of hazardous chemicals may include in addition to the materials set forth herein, other type or kinds of materials either now known or later developed in the future for absorbing such other type or kinds of hazardous chemicals.

What is claimed is:

1. A bib comprising:
an absorbent pad having one or more protection layers made of a bio-chemical absorbent material;
the absorbent pad having a top portion configured with an opening for receiving and engaging a neck of a fuel opening of a tank of a vehicle or vessel so that the bib can be hung on the neck when a bio-chemical fuel is being dispensed in the tank;
the absorbent pad also having a bottom portion configured for hanging below the opening so as to absorb at least some of the bio-chemical fuel that may spill either when a nozzle for dispensing the bio-chemical fuel is inserted into or removed from the fuel opening, or when the tank is over-filled.

2. The bib of claim 1, wherein the top portion comprises circumferential portions arranged about the opening and configured to flex and frictionally engage the neck so that the bib hangs securely on the tank.

3. The bib of claim 2, wherein the circumferential portions include eight circumferential portions symmetrically arranged about the opening.

4. The bib of claim 2, wherein each adjacent pair of the circumferential portions is separated by a respective radial cut in the absorbent pad.

5. The bib of claim 4, wherein the top portion is configured with diametrically opposing pairs of radial cuts having longer and shorter lengths so that alternating adjacent circumferential portions flex open wider for hanging the bib on the tank.

6. The bib of claim 1, wherein the top portion comprises circumferential portions formed or shaped as wrinkles, folds or alternating ridges about the opening and configured to flex and frictionally engage the neck so that the bib hangs securely on the tank.

7. The bib of claim 1, wherein said vehicle or vessel includes a passenger vehicle, a motorcycle, a marine vessel, an airplane.

8. The bib of claim 1, further comprising a flame-retardant material disposed thereon.

9. The bib of claim 1, wherein the bottom portion is configured to include a logo formed, affixed or imprinted thereon for providing advertising.

10. The bib of claim 2, wherein said circumferential portions are serrated or perforated.

11. The bib of claim 1, further comprising:
the bottom portion comprises a form-molded catch basin, said catch basin comprising:
a first protection layer configured to be continuous with said absorbent pad,
a second protection layer configured to be coupled on top of said first protection layer,
a third protection layer configured to be coupled on top of said second protection layer, said first, second and third protection layers comprised of a biochemical absorbent material, and
a flexible formable material coupled to said first protection layer.

12. The bib of claim 11 further comprising a flexible tapered formable material coupled to said opening of said absorbent pad for further coupling with said fuel opening, said flexible tapered formable material configured to provide structural stability so that the bib hangs securely on the tank.

13. The bib of claim 1, further comprising an adhesive foil disc affixed to one surface of said absorbent pad, said adhesive foil disc configured to provide structural formability to the bib and stability of the coupling of the bib to the neck of the fuel opening so that the bib hangs securely on the tank.

14. The bib of claim 1, wherein the biochemical absorbent material is made of polypropylene.

15. A protective fueling apparatus, comprising:
a catch cylinder comprising a cylindrical structure having a catch flange and a back flap,
said catch cylinder made of a durable plastic material,
said back flap configured with an opening,
a filler extension tube configured for engaging with said opening, said filler extension tube configured for receiving and engaging a neck of a fuel opening of a tank of a vehicle or vessel so that the catch cylinder can be hung on the neck when a bio-chemical fuel is being dispensed in the tank, and
an absorbent sock comprised of a bio-chemical absorbent material and filled with another bio-chemical absorbent material, said sock dimensionally sized to fit inside said catch cylinder.

16. The protective fueling apparatus of claim 15, wherein said vehicle is a marine vessel or an airplane.

17. The protective fueling apparatus of claim 15, further comprising a flame-retardant material disposed on said biochemical absorbent material.

18. The protective fueling apparatus of claim 15, further configured to comprise a logo formed, affixed or imprinted thereon for providing advertising.

19. The protective fueling apparatus of claim 15, further comprising a flame-retardant material disposed on said absorbent sock.

20. The protective fueling apparatus of claim 15, wherein the bio-chemical absorbent material is polypropylene and the other bio-chemical absorbent material is hydrophobic cellulose with fire retardant.

21. A bib comprising:
an absorbent pad having one or more protection layers made of a material configured for absorbing hazardous chemicals;
the absorbent pad having a top portion configured with an opening for receiving and engaging a neck of an opening of a tank of a vehicle or vessel so that the bib can be hung on the neck when a fluid is being dispensed in the tank;
the absorbent pad also having a bottom portion configured for hanging below the opening so as to absorb at least some of the fluid that may spill either when a nozzle for dispensing the fluid is inserted into or removed from the fluid opening, or when the tank is over-filled.
